(19) United States
(12) Patent Application Publication
(10) Pub. No.: US 2016/0346860 A1
(43) Pub. Date: Dec. 1, 2016

(54) WELDING METHOD

(71) Applicant: ROLLS-ROYCE plc, London (GB)

(72) Inventor: Thomas Fernley FLINT, Manchester (GB)

(73) Assignee: ROLLS-ROYCE plc, London (GB)

(21) Appl. No.: 15/146,386

(22) Filed: May 4, 2016

(30) Foreign Application Priority Data
May 28, 2015 (GB) 1509152.3

(51) Int. Cl. B23K 9/095

(52) U.S. Cl. CPC B23K 9/0953; B23K 9/095

(57) ABSTRACT

A method of welding two adjacent components together includes determining geometrical dimensions of the components to be welded and determining material properties of the components to be welded. The method includes selecting an optimised weld torch velocity and voltage by selecting an iteration parameter of weld torch velocity and voltage, and calculating an expected heat flux distribution that will be generated in components during a welding process as a function of the geometrical dimensions of the components and the material properties of the components. The heat flux distribution is constrained to be ellipsoidal in an initial weld region and conical in the remainder of the weld. The method includes iterating using the iteration parameter until an optimised weld torch velocity and voltage is obtained. The welding torch is then set to weld the components at the determined optimum velocity and voltage.

### TECHNICAL FIELD

The present disclosure concerns a method of welding and/or apparatus used for welding.

### BACKGROUND

Many structures and assemblies of a nuclear power plant are manufactured by welding large components together. The components are generally thick-walled components, for example 10 mm to 350 mm thick, designed to meet process and regulatory requirements for a nuclear power plant. Pressure vessels of a nuclear power plant often have a wall thickness greater than or equal to 200 mm. The welds of these thick walled components need to be designed to maintain component integrity during in-service conditions.

To form the joint between thick-walled components, multiple weld passes may be required. A failure causing the welding process to stop part-way through the welding of components can result in the components being scraped.

When the weld (often referred to as the weldment) between components cools a stress remains and the components are distorted from their original shape. Such residual stresses affect the in-service performance of the resulting welded structure. In particular, low temperature brittle fracture, fatigue, stress corrosion cracking, and buckling can be significantly aggravated by residual stresses in weldments.

The integrity of large nuclear components such as reactor pressure vessels depends largely on the residual stresses that are introduced during the welding process. Factors such as the choice of welding process, groove geometry and welding parameters all contribute to the final stress state. As such, it is important that the welding process is correctly designed to ensure that the final component meets the process requirements for a nuclear power plant.

Physical experiments are time consuming and expensive. Accordingly, the welding process used to form a weldment is often designed with the use of finite element analysis. The transient temperature field of a welded joint is directly related to the residual stress in the region of the joint, in particular to the size of the fusion zone and heat affected zone. Accordingly, the finite element thermal analysis of a welding process involves the solution of a heat transfer problem with a highly concentrated heat source in motion. There are various heat source models used depending on factors such as the type of welding process and the depth of the weld. However, none of the current models are sufficiently accurate to model the types of welds used in the nuclear industry, e.g. thick components welded using arc welding, or electron or laser beam welding.

### SUMMARY OF DISCLOSURE

In a first aspect there is provided a method comprising selecting an optimised weld torch velocity and voltage (e.g. by selecting an iteration parameter of weld torch velocity and/or voltage). An expected heat flux distribution that will be generated in components during a welding process is calculated as a function of the geometrical dimensions of the components and the material properties of the components. The heat flux distribution is constrained to be ellipsoidal in an initial weld region and conical in the remainder of the weld. The method further includes optimising (e.g. by iterating using the iteration parameter) until an optimised weld torch velocity and voltage is obtained.

Reference to a heat flux distribution having a conical or ellipsoidal distribution refers to lines of constant power density laying respectively on a three dimensional conical or three dimensional ellipsoidal surface.

In a second aspect there is provided a method comprising using a trained neural network to select an optimised weld torch velocity and voltage. The neural network was trained by calculating an expected heat flux distribution that will be generated in components during a welding process as a function of the geometrical dimensions of the components and the material properties of the components. The heat flux distribution was constrained to be ellipsoidal in an initial weld region and conical in the remainder of the weld.

In a third aspect there is provided a method comprising determining the expected heat flux distribution to have been formed during the formation of a partial weld between components as a function of the velocity and voltage of the weld torch used to form the partial weld, as a function of the time taken to form the partial weld, and as a function of the geometrical dimensions of the components and the material properties of the components, wherein the heat flux distribution is constrained to be ellipsoidal in an initial weld region and conical in the remainder of the weld. The method further comprises computationally solving for the expected residual stress based on the expected heat flux distribution.

The heat flux generated during the welding process may be estimated to have a double ellipsoidal distribution in the initial region of the weld, and a double conical distribution in the remainder of the weld.

For example, the conical distribution can be considered to be formed of two conics having a different radius at any given point, and/or a different rate of change of radius. The longitudinal axis of each conic may be parallel. The longitudinal axis of each conic may extend in the thickness direction of the components at the position of the weld.

The ellipsoidal distribution may be defined by two ellipsoids having a different maximum axial length in one or more positions. For example, an ellipsoid can be described by the Cartesian coordinates

$$\frac{{x}^{2}}{{a}^{2}} + \frac{{y}^{2}}{{b}^{2}} + \frac{{z}^{2}}{{c}^{2}} = 1 ,$$

where the semi-axes are of lengths a, b and c. One or more of the lengths a, b or c of one of the ellipsoids may be different to the corresponding lengths a, b or c of the other ellipsoid.

The heat flux distribution can be estimated as being split into four quadrants; one quadrant being a segment of a conic having a radius R1 that varies in the thickness direction, one quadrant being a segment of a conic having a radius R2 that varies in the thickness direction, one quadrant being a segment of an ellipsoid having semi-axes of length R3ₐ, R3_{b}, R3_{c}, and one quadrant being a segment of an ellipsoid having semi-axes of length R4ₐ, R4_{b}, R4_{c}.

In a fourth aspect there is provided a method of welding two adjacent components together comprising performing the method of the first or second aspect. The method may comprise determining geometrical dimensions of the components to be welded. The method may comprise determining material properties of the components to be welded. The method may further comprise setting the welding torch to weld the components at said determined optimum velocity and voltage.

The method of the fourth aspect can contribute to improving the quality of the weld of a component. Furthermore, it is possible to reduce the production time for welding components because optimisation of the welding torch velocity and voltage can in some cases result in a faster weld, because some of the redundancy in the process can be eliminated.

In a fifth aspect there is provided a method of completing a partial weld between two components, the method including determining geometrical dimensions of the components to be welded; determining material properties of the components to be welded; and determining the velocity and the voltage of the weld torch used to form the partial weld and the time taken to form the partial weld. The method further comprises determining the expected residual stress due to the formation of the partial weld using the method according to the third aspect. The method may further comprise comparing the expected residual stress to a threshold, and (i) under the condition that the residual stress is above a predetermined threshold scrapping said components, or (ii) under the condition that the residual stress is below a predetermined threshold heat treating the components.

For example, the components may be heat treated at a temperature and for a length of time determined as a function of the residual stress determined to be in the components.

The method of the fifth aspect can provide improved information relating to the component, and in some embodiments this information can be provided in a much shorter period of time than is possible in the prior art. As such, the number of components scrapped can be reduced, and also the heat treatment time can be reduced. In the prior art, because it takes so long to calculate the estimated residual stress components are often heat treated for long periods of time to increase confidence that any residual stresses are relaxed before welding is recommenced.

The method may include determining the optimal voltage and velocity required to complete the weld using the method of the first and/or second aspect.

Neural networks may be used to determine the optimum voltage and velocity. The thermal strains can be calculated using the method of the first or second aspect and point at which the electron beam failed can be inputted. Firmware may calculate the optimal welding input parameters to negate extra thermal strains and achieve an optimised weld with the re-initiated electron beam. The start location for the welding process to re-commence can be calculated using heat flux distribution that is constrained to be ellipsoidal in an initial weld region and conical in the remainder of the weld.

The components may be welded using arc welding.

The method may comprise providing a filler material in the form of a wire. The method may comprise determining the wire feed speed used in the welding process as a function of the expected heat flux distribution.

The components may be welded using electron beam welding or laser welding.

The method may comprise using temperature sensors to measure the temperature of the components during the welding process, and modifying said heat flux distribution as a function of the measured temperature.

For example, temperatures sensors such as thermocouples may be provided on the components.

The method may include calculating a correction factor and modifying the optimum velocity and voltage of the weld torch as a function of the correction factor.

The geometry of the weld preparation may be determined as a function of the expected heat flux distribution.

The method may comprise analytically computing the transient thermal field as a function of the heat flux distribution.

The transient thermal field (T) may be proportional to the integral:

$${\int }_{0}^{t} \{ \begin{matrix}( {Q}_{{0}_{c r}} {B}_{T} {D}_{T} {L}_{{T}_{r}} ) + ( {Q}_{{0}_{c f}} {B}_{T} {D}_{T c} {L}_{T f} ) + \\ ( {Q}_{{0}_{D r}} {B}_{T} {D}_{T e} {L}_{{T}_{r}} ) + ( {Q}_{{0}_{d f}} {B}_{T} {D}_{T e} {L}_{T f} )\end{matrix} \} d t$$

wherein Q_{0cr}, Q_{0cf}, Q_{0Dr}, Q_{0dr} is the maximum heat flux in a respective quadrant of the distribution; B_{T} is a heat kurnel in the x-coordinate; D_{T}, D_{Te}, D_{TC} is a is a heat kurnel in the y-coordinate; and L_{Tr}, L_{Tf} is a is a heat kurnel in the z-coordinate.

Analytically solving for the transient thermal field has been found to significantly reduce the process time. In particular, when using the above mentioned integral, experiments showed the time to solve for the transient thermal field to be approximately 1 day.

However, when using methods of the prior art, the time to solve for the transient thermal field of a comparable welded component was approximately 8 days.

In a sixth aspect there is provided an apparatus comprising at least one processor, at least one memory comprising computer readable instructions; the at least one processor being configured to read the computer readable instructions and cause performance of the method of any one of the first, second and/or third aspects.

In a seventh aspect there is provided an apparatus comprising a controller to cause performance of the method of the first, second and/or third aspects.

In an eighth aspect there is provided an apparatus comprising processor circuitry to cause performance of the method of the first, second and/or third aspects.

In a ninth aspect there is provided an apparatus comprising a controller having at least one processor and at least one memory, an input device for receiving information relating to material geometry and/or properties, the controller being configured to receive information from the input device; and an output device for displaying an outcome of a calculation performed by the controller; wherein the controller is configured to perform the method according to the first, second and/or third aspects.

The apparatus may comprise welding equipment having a weld torch and an actuator. The welding equipment may be configured to receive a signal indicative of the optimum voltage and velocity of the weld torch from the controller, and the actuator may be configured to operate the weld torch at said optimum voltage and velocity.

The welding apparatus may comprise an input device for receiving user inputs. The welding apparatus may be configured to receive a signal from the controller via a connection between the controller and the welding apparatus, or via a user inputting information relating to the optimum voltage and velocity displayed on the output device to the input device of the welding apparatus.

The apparatus may comprise one or more sensors for measuring the temperature of a component during a welding process. The sensors may be arranged to send a signal to the controller indicative of the measured temperature.

In a tenth aspect there is provided a computer program that, when read by a computer, causes performance of the method of the first, second and/or third aspects.

In an eleventh aspect there is provided a non-transitory computer readable storage medium comprising computer readable instructions that, when read by a computer, causes performance of the method of the first, second and/or third aspects.

In a twelfth aspect there is provided a method of training an neural network including calculating an expected heat flux distribution that will be generated in components during a welding process as a function of the geometrical dimensions of the components and the material properties of the components, and wherein the heat flux distribution was constrained to be ellipsoidal in an initial weld region and conical in the remainder of the weld.

In a thirteenth aspect there is provided a method comprising training a neural network using the method according to the twelfth aspect, and selecting an optimised welding velocity and voltage using the trained neural network.

### DESCRIPTION OF THE DRAWINGS

Embodiments of the invention will now be described by way of example only, with reference to the Figures, in which:

FIG. 1 is a partial sectional view through the welding axis of a welded structure in the region of a weld;

FIG. 2 is a schematic of welding apparatus and a component being welded;

FIG. 3 is a schematic of an apparatus including the welding apparatus of FIG. 2;

FIG. 4 is a flow diagram illustrating a method of welding two components;

FIG. 5 is a flow diagram illustrating an alternative method of welding two components;

FIGS. 6 and 7 are diagrams illustrating the constraints applied to define the expected heat distribution.

### DETAILED DESCRIPTION

Many metallic structures in the nuclear industry are fabricated by welding metallic components together, for example reactor vessels. Given the environment the structures operate in, the components are often thick walled (for example a thick-walled pressure vessel may have a wall thickness equal to or greater than 200 mm, for example equal to or between 250 mm and 350 mm) and the weld needs to maintain its structural integrity under the hostile conditions of a nuclear power plant.

Methods for welding a component in the nuclear industry include arc welding, electron beam welding, or laser welding. In arc welding, an electric arc is created between an electrode and the components to be welded. In the nuclear industry, the electrode is generally consumable to provide a filler material for the weld. In electron beam welding a focussed stream of high energy electrons, and in laser beam welding a concentrated heat source, is used to melt the metal of the components to form the weld, as such no filler material is required.

The surfaces of the components to be welded together are generally prepared in some way before the welding process starts. Various weld preparations exist and these are understood in the art. An example weld preparation is to form a groove between the components, for example by providing a tapered portion of each component in the region of the weld. However, in alternative embodiments no groove may be provided and instead the faces of the components may be opposed and generally parallel.

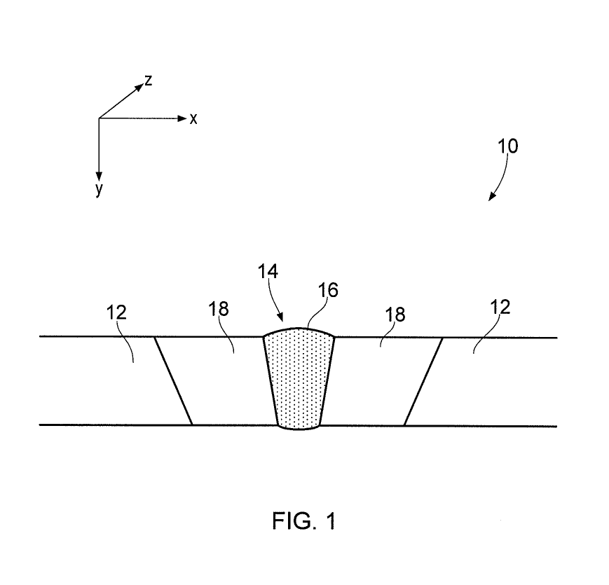

An example of a portion of a structure of a nuclear power plant is indicated generally at 10 in FIG. 1. The structure 10 includes two components 12. The components 12 are joined together via a weldment 14. In this example, the components had a weld preparation in the form of a groove before welding. The final component 10 includes a fusion zone 16 of material that has melted (either filler material and/or material of the components 12) and a heat affected zone 18. The heat affected zone is material that was not melted during the welding process but was heated. After welding, when the weldment cools a stress remains in the fusion zone and heat affected zone. Residual stresses such as this can affect the in-service performance of welded structures. In particular, low temperature brittle fracture, fatigue, stress corrosion cracking, and buckling can be significantly aggravated by residual stresses in weldments. As such, it is important to reduce the residual stresses in a weld through the correct design of the weld parameters. The following describes a method and equipment used to form a weld between two components, such as thick components used in the nuclear industry, with minimal residual stress.

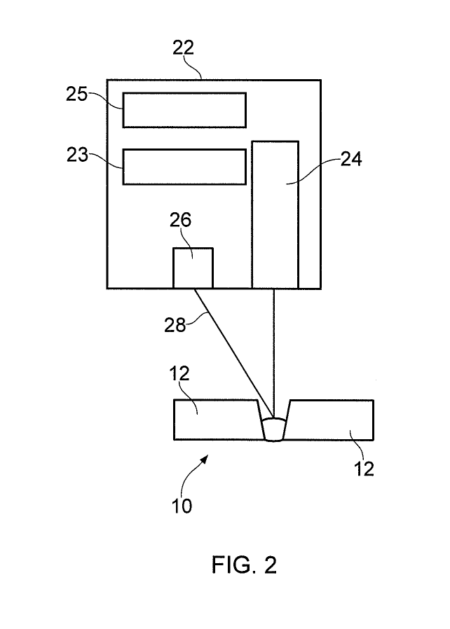

Referring now to FIG. 2, welding apparatus for use in forming a weldment between two components 12 is indicated at 22.

In this example the weld preparation between the two components is a groove with angled sides. The components will have a given geometry which may be defined at least by the thickness of the two components and the length of the edge or portion of the edge requiring welding. The properties of the components to be welded will depend on the material the components are made from and the processes the components have been subjected to during manufacture, which can affect the microstructure of the components.

The welding apparatus 22 includes a welding torch 24. In this example the welding torch is an arc welding torch, and the welding apparatus 22 includes a wire feed 26 that feeds a wire 28 along the weld, the wire providing, in use, filler for the weld. In alternative examples, the welding torch of the welding apparatus may be a laser beam welding torch or an electron beam welding torch, and in these examples the wire feed and/or wire may not be provided as no filler material is needed for these types of weld.

The welding apparatus 22 may further comprise an input device 23. The input device may be configured to receive signals from a controller (as will be later described), or may be configured to receive user input to allow a user to control the operation of the welding apparatus. The input device may comprise one or more of, or any combination of: a keyboard, a keypad, a touchscreen display, a computer mouse, and a touchpad.

The welding apparatus 22 may further comprise an actuator 25 for actuating the welding torch according to instructions received from the user input device 23 or alternatively according to instructions received from the controller via a signal transmitted from the controller to the welding apparatus.

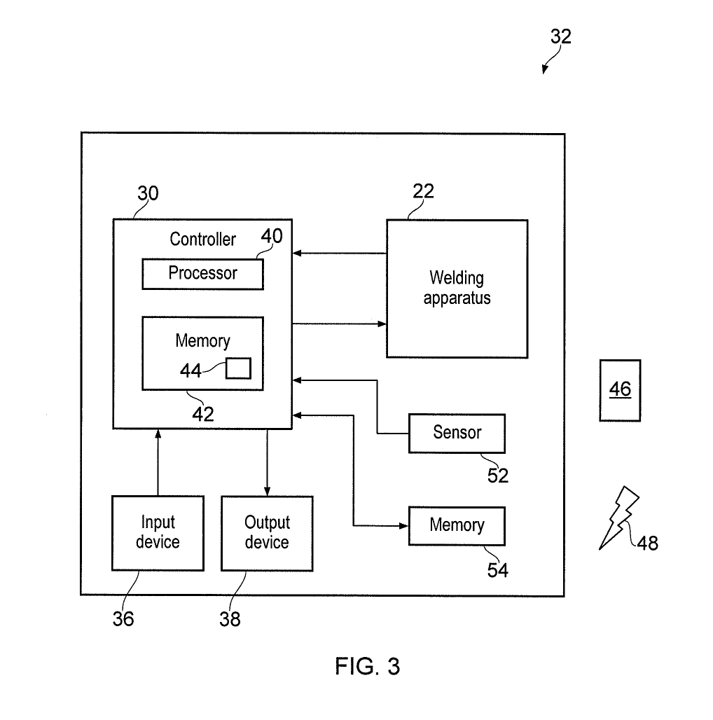

FIG. 3 illustrates a schematic diagram of apparatus 32 for controlling welding according to various examples. The apparatus 32 includes the controller 30, an input device 36, an output device 38, and the welding apparatus 22. Optionally, the apparatus 32 may include a further memory 54, and/or one or more sensors 52. In some examples, the apparatus 32 may be a single, unitary device where the controller 30, the actuator 34, the input device 36, the output device 38, the further input device, the sensor and the welding apparatus 22 are physically coupled together. In other examples, the apparatus 32 may be an apparatus that is distributed across a plurality of different locations (for example, the apparatus 32 may be distributed across different cities, different counties or different countries).

In some examples, the apparatus 32 may be a module. As used herein, the wording ‘module’ refers to a device or apparatus where one or more features are included at a later time, and possibly, by another manufacturer or by an end user. For example, where the apparatus 32 is a module, the apparatus 32 may only include the controller 30, and the remaining features may be added by another manufacturer, or by an end user.

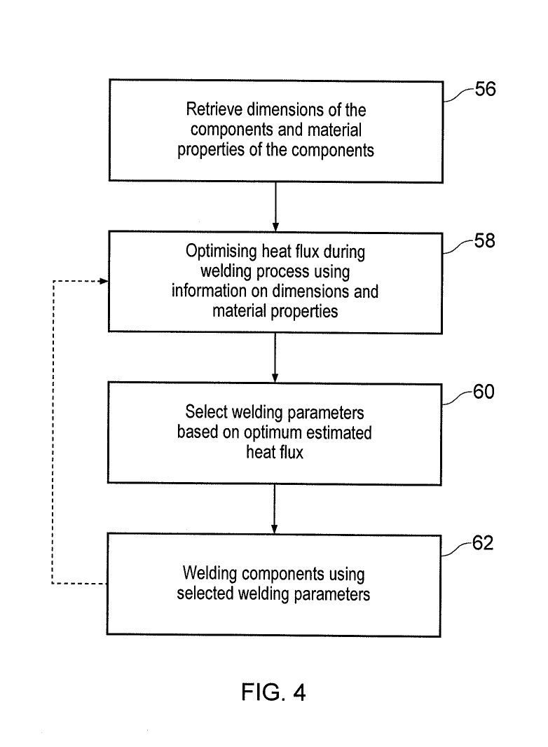

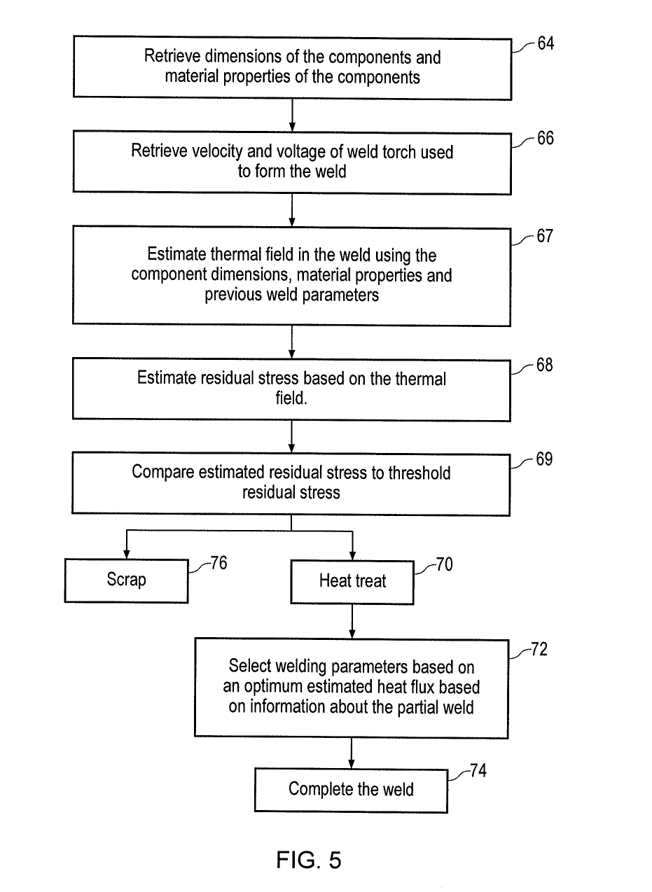

The controller 30 may comprise any suitable circuitry to cause performance of at least part of the methods described herein and as illustrated in FIGS. 4 and 5. The controller 30 may be a computer. The controller 30 may comprise any of, or combination of: application specific integrated circuits (ASIC); field programmable gate arrays (FPGA); single or multi-processor architectures; sequential (Von Neumann)/parallel architectures; programmable logic controllers (PLCs); microprocessors; and microcontrollers, to perform the methods.

By way of an example, the controller 30 may comprise at least one processor 40 and at least one memory 42. The memory 42 stores a computer program 44 comprising computer readable instructions that, when read by the processor 40, causes performance of at least part of the methods described herein, and as illustrated in FIGS. 4 and 5. The computer program 44 may be software or firmware, or may be a combination of software and firmware.

A further memory 54 may be provided. The further memory 54 may store a database, for example a database of material properties. The further memory may form part of the controller or alternatively the further memory may be separate from the controller and accessed by the controller to provide information to the controller regarding information in the stored database, e.g. material properties data.

The processor 40 may be located on the welding apparatus 22 or may be located remote from the welding apparatus 22, or may be distributed between the welding apparatus 22 and a location remote from the welding apparatus 22. The processor 40 may include at least one microprocessor and may comprise a single core processor, or may comprise multiple processor cores (such as a dual core processor or a quad core processor).

The memory 42 may be located on the welding apparatus 22, or may be located remote from the welding apparatus 22, or may be distributed between the welding apparatus 22 and a location remote from the welding apparatus 22. The memory 42 may be any suitable non-transitory computer readable storage medium, data storage device or devices, and may comprise a hard disk and/or solid state memory (such as flash memory). The memory 42 may be permanent non-removable memory, or may be removable memory (such as a universal serial bus (USB) flash drive).

The computer program 44 may be stored on a non-transitory computer readable storage medium 46. The computer program 44 may be transferred from the non-transitory computer readable storage medium 46 to the memory 42. The non-transitory computer readable storage medium 46 may be, for example, a USB flash drive, a compact disc (CD), a digital versatile disc (DVD) or a Blu-ray disc. In some examples, the computer program 44 may be transferred to the memory 42 via a wireless signal 48 or via a wired signal 48.

The input device 36 may be a user input device. For example, the input device may comprise one or more of, or any combination of: a keyboard, a keypad, a touchscreen display, a computer mouse, and a touchpad.

The output device 38 may be any suitable device for presenting information to a user of the apparatus 32. The output device 38 may comprise a display (such as a liquid crystal display (LCD), a light emitting diode (LED) display, or a thin film transistor (TFT) display for example). For example, the output device may display information relating to the recommended velocity of the welding torch, the recommended power of the welding torch, and/or the recommended wire feed speed. The controller 30 may be configured to cause the output display to display said information relating to the operating parameters of the welding apparatus 22. In addition or alternatively, the controller may be configured to output a signal to the welding apparatus, the signal may indicate the recommended velocity of the welding torch, the recommended power of the welding torch, and/or the recommended wire feed speed.

The one or more sensors 52 may be provided to sense in process properties of the components 12 in the region of the weld during the welding process. For example the sensors may be configured to sense temperature. The sensors may be configured to sense temperature remotely, for example using infrared, or alternatively the sensors may be positioned on the components, for example the sensors may comprise one or more thermocouples. The sensors may be provided on the welding apparatus or may be remote from the welding apparatus. The sensors may be configured to send information to the controller 30 at set intervals, continuously, or upon request by the controller.

The method of operation of the apparatus 32 will now be described in more detail with reference to FIGS. 4 and 5.

Firstly the method illustrated in FIG. 4 will be described. Two components 12 to be welded are provided. At block 56, the geometry and/or dimensions of the components and the material properties of the components are inputted to the controller 30. The geometry and/or dimensions of the components may be inputted to the controller via the input device 36. The geometry may be manually measured and the data manually inputted, alternatively the geometry may be measured using automated equipment for example coordinate measurement equipment using either a probe or a laser, further alternatively a user may input an identifier that can be used by the controller to retrieve dimensions from a database stored on an internal or external memory for example memory 54. The geometry of particular importance is the thickness of the components in the region of the weld and also the length of the weld.

The material properties of the components 12 are inputted to the controller 30, using the input device 36 and/or by the controller retrieving data from a database stored on an internal or external memory for example memory 54. The material properties retrieved may include information relating to the mircrostructure, of the components. The material properties of the components may be determined from tests on the components, tests on test pieces formed with the components, and/or from material property tables and databases.

At block 58, the heat flux distribution that will be generated during welding is optimised. As previously mentioned, the heat flux distribution generated during welding is related to the residual stress produced, and as such optimising the heat flux distribution can minimise residual stresses in a welded component structure 10. The controller 30 may be configured to optimise the heat flux distribution by selecting an iteration parameter of the velocity of the welding torch 24 and the voltage of the welding torch 24. The heat flux for the iteration parameter may then be determined, and the controller may be configured to iterate using the iteration parameter so as to calculate an optimised heat flux distribution.

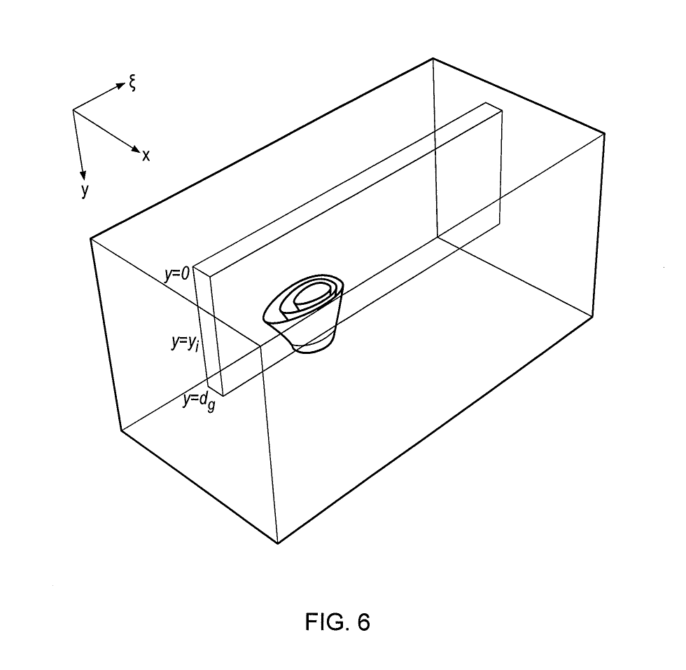

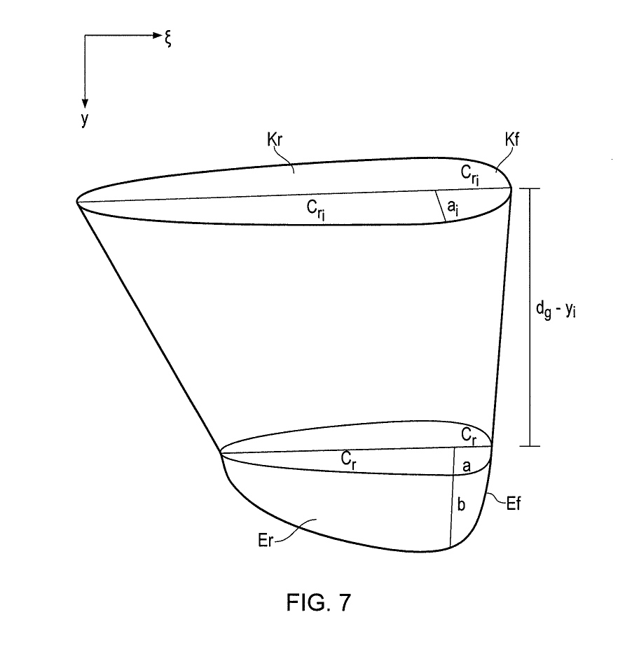

The heat flux is determined by assuming the heat flux distribution to have a conical distribution in a first portion of the components and an ellipsoidal distribution in a second portion of the components, the first portion being adjacent the second portion in the thickness direction (or in the direction of the y-axis of FIG. 1). The heat flux distribution can be described in more detail with reference to FIGS. 6 and 7.

The coordinate system used in FIGS. 6 and 7 is a moving coordinate system. The weld depth is in the direction of the y-axis which may also be referred to as the thickness direction, and the width of the weld extends across the x-axis. The ξ-axis extends along the length of the weld and is given by z+vt, where z is the position along the length of the weld, v is the velocity of the weld torch, and t is time.

In FIGS. 6 and 7, y=0 denotes the top of the preparation groove (or components), that is, the last point in the thickness (or y-direction) that is welded during the welding process. y=d_{g} indicates the base of what can be termed the groove (which is different to the weld preparation groove), this is approximately the position where the material is fused together at the base to define a groove between the components which is filled during the welding process. As will be explained later, y=d_{g} marks a transition in form of the heat flux distribution. yᵢ is the position of the welding filament (which may be referred to as the arc initiation depth).

The heat flux distribution below the plane y=d_{g} has an ellipsidal distribution, preferably a double ellipsoidal distribution. Above the plane y=d_{g}, the heat flux distribution has a conical distribution, preferably a double conical distribution. The distribution can be considered to have four quadrants Er, Ef, Kr and Kf. This double ellipsoidal—double conical distribution has been found by the inventor to provide the most accurate estimate of the heat flux distribution.

The heat flux distribution can be described using the following expression:

$$q = V I η \times \{ \begin{matrix}\frac{6 \sqrt{3} {R}_{{r}_{d e}} {e}^{- 3 ( {( \frac{x - {b}_{g}}{a} )}^{2} + {( \frac{y - {d}_{g}}{b} )}^{2} + {( \frac{ξ}{{c}_{r}} )}^{2} )}}{a {c}_{r} b π \sqrt{π}} ∀ ( y \geq {d}_{g} ) , ( ξ \leq 0 ) \\ \frac{6 \sqrt{3} {R}_{{f}_{d e}} {e}^{- 3 ( {( \frac{x - {b}_{g}}{a} )}^{2} + {( \frac{y - {d}_{g}}{b} )}^{2} + {( \frac{ξ}{{c}_{f}} )}^{2} )}}{a {c}_{f} b π \sqrt{π}} ∀ ( y \geq {d}_{g} ) , ( ξ \geq 0 ) \\ \frac{54 {e}^{3} {R}_{{r}_{conical}} {e}^{- 3 ( {( \frac{ξ}{{Γ}_{{c}_{r}}} )}^{2} + {( \frac{x - {b}_{g}}{{Γ}_{a}} )}^{2} )}}{{π}^{2} ( {e}^{3} - 1 ) {S}_{r} ( {d}_{g} - {y}_{i} )} ∀ ( y \leq {d}_{g} ) , ( ξ \leq 0 ) \\ \frac{54 {e}^{3} {R}_{{r}_{conical}} {e}^{- 3 ( {( \frac{ξ}{{Γ}_{{c}_{f}}} )}^{2} + {( \frac{x - {b}_{g}}{{Γ}_{a}} )}^{2} )}}{{π}^{2} ( {e}^{3} - 1 ) {S}_{f} ( {d}_{g} - {y}_{i} )} ∀ ( y \leq {d}_{g} ) , ( ξ \geq 0 )\end{matrix}$$

where V is the voltage of weld torch; I is the current of weld torch; η is the efficiency of weld torch; ξ is z-vt; x, y, z are geometrical coordinates of the distribution; v is the velocity of weld torch; t is the time; a,b,cᵣ,c_{f},b_{g} are the parameters defining the spatial gradient of the heat flux; d_{g} is the depth of the groove, Sᵣ=cᵣ(2a+aᵢ)+cᵣᵢ(2aᵢ+a); S_{f}=c_{f}(2a+aᵢ)+c_{fi}(2aᵢ+a); ┌ₐ=a-((a-aᵢ)(d_{g}-y/(d_{g}-Yᵢ)); ┌_{cr}=cᵣ-((cᵣ-cᵣᵢ)(d_{g}-y/(d_{g}-yᵢ)); ┌_{cf}c_{f}-((c_{f}-c_{fi})(d_{g}-y/(d_{g}-yᵢ)); yᵢ is the location of the welding filament,

$$\begin{matrix}{R}_{{r}_{d e}} = \frac{2}{1 + \frac{{c}_{f}}{{c}_{r}} + \frac{( {e}^{3} - 1 ) \sqrt{\frac{π}{3}} {S}_{f} ( {d}_{g} - {y}_{i} )}{3 b {c}_{r} {e}^{3} a} + \frac{( {e}^{3} - 1 ) \sqrt{\frac{π}{3}} {S}_{r} ( {d}_{g} - {y}_{i} )}{3 b {c}_{r} {e}^{3} a}} ; \\ {R}_{{f}_{de}} = \frac{2}{1 + \frac{{c}_{r}}{{c}_{f}} + \frac{( {e}^{3} - 1 ) \sqrt{\frac{π}{3}} {S}_{f} ( {d}_{g} - {y}_{i} )}{3 b {c}_{f} {e}^{3} a} + \frac{( {e}^{3} - 1 ) \sqrt{\frac{π}{3}} {S}_{r} ( {d}_{g} - {y}_{i} )}{3 b {c}_{f} {e}^{3} a}} ; \\ {R}_{{r}_{concial}} = \frac{2}{1 + \frac{{S}_{f}}{{S}_{r}} + \frac{3 b {c}_{f} {e}^{3} \sqrt{\frac{3}{π}} a}{( {e}^{3} - 1 ) {S}_{r} ( {d}_{g} - {y}_{i} )} + \frac{3 b {c}_{r} {e}^{3} \sqrt{\frac{3}{π}} a}{( {e}^{3} - 1 ) {S}_{f} ( {d}_{g} - {y}_{i} )}} ; \\ {R}_{{f}_{concial}} = \frac{2}{1 + \frac{{S}_{r}}{{S}_{f}} + \frac{3 b {c}_{f} {e}^{3} \sqrt{\frac{3}{π}} a}{( {e}^{3} - 1 ) {S}_{f} ( {d}_{g} - {y}_{i} )} + \frac{3 b {c}_{r} {e}^{3} \sqrt{\frac{3}{π}} a}{( {e}^{3} - 1 ) {S}_{r} ( {d}_{g} - {y}_{i} )}} ;\end{matrix}$$

The double conical distribution and the double ellipsoidal distribution are equal at the position of change between the distributions (i.e. when y=d_{g}). In the four quadrants of the distribution the factors are found such that the total integral of the distribution is unity and the distributions are equal at the point where the four quadrants meet.

In exemplary embodiments, the heat flux distribution may be optimised by analytically solving for the heat flux distribution. The above described heat flux model has been developed so that it can be easily and accurately solved using Green's functions derived by the inventor.

The Greens functions developed are described below:

The transient thermal field T is equal to or proportional to

$${\int }_{0}^{t} \{ \begin{matrix}( {Q}_{{0}_{c r}} {B}_{T} {D}_{{T}_{c}} {L}_{{T}_{r}} ) + ( {Q}_{{0}_{c f}} {B}_{T} {D}_{T c} {L}_{{T}_{f}} ) + \\ ( {Q}_{{0}_{D r}} {B}_{T} {D}_{T e} {L}_{{T}_{r}} ) + ( {Q}_{{0}_{D f}} {B}_{T} {D}_{T e} {L}_{{T}_{f}} )\end{matrix} \} d {t}^{′}$$

Where Q_{0cr}, Q_{0cf}, Q_{0Dr}, Q_{0Df} are the maximum heat flux in a respective quadrant of the distribution;

$$\begin{matrix}{B}_{T} = {\int }_{0}^{B} \frac{\begin{matrix}( Exp [ - \frac{{( ( 2 n b ) + x - {x}^{′} )}^{2}}{4 α ( t - {t}^{′} )} ] + \\ Exp [ - \frac{{( ( 2 n B ) + x + {x}^{′} )}^{2}}{4 α ( t - {t}^{′} )} ] )\end{matrix}}{\sqrt{4 πα ( t - {t}^{′} )}} ( Exp [ - 3 {( \frac{{x}^{′} - {b}_{g}}{a} )}^{2} ] ) d {x}^{′} ; \\ {D}_{{T}_{e}} = {\int }_{{d}_{g}}^{D} \frac{\begin{matrix}( Exp [ - \frac{{( ( 2 n D ) + y - {y}^{′} )}^{2}}{4 α ( t - {t}^{′} )} ] + \\ Exp [ - \frac{{( ( 2 n D ) + y + {y}^{′} )}^{2}}{4 α ( t - {t}^{′} )} ] )\end{matrix}}{\sqrt{4 πα ( t - {t}^{′} )}} ( Exp [ - 3 {( \frac{{y}^{′} - {d}_{g}}{b} )}^{2} ] ) d {y}^{′} ; \\ {L}_{{T}_{r}} = {\int }_{0}^{v {t}^{′}} \frac{\begin{matrix}( Exp [ - \frac{{( ( 2 n L ) + z - {z}^{′} )}^{2}}{4 α ( t - {t}^{′} )} ] + \\ Exp [ - \frac{{( ( 2 n L ) + z + {z}^{′} )}^{2}}{4 α ( t - {t}^{′} )} ] )\end{matrix}}{\sqrt{4 πα ( t - {t}^{′} )}} ( Exp [ - 3 {( \frac{{z}^{′} - ( v {t}^{′} )}{{c}_{r}} )}^{2} ] ) d {z}^{′} ; \\ {L}_{{T}_{f}} = {\int }_{v {t}^{′}}^{L} \frac{\begin{matrix}( Exp [ - \frac{{( ( 2 n L ) + z - {z}^{′} )}^{2}}{4 α ( t - {t}^{′} )} ] + \\ Exp [ - \frac{{( ( 2 n L ) + z + {z}^{′} )}^{2}}{4 α ( t - {t}^{′} )} ] )\end{matrix}}{\sqrt{4 πα ( t - {t}^{′} )}} ( Exp [ - 3 {( \frac{{z}^{′} - ( v {t}^{′} )}{{c}_{f}} )}^{2} ] ) d {z}^{′} ; \\ and \\ {D}_{{T}_{c}} = {\int }_{{y}_{i}}^{d g} \frac{( Exp [ - \frac{{( ( 2 n D ) + y - {y}^{′} )}^{2}}{4 α ( t - {t}^{′} )} ] + Exp [ - \frac{{( ( 2 n D ) + y + {y}^{′} )}^{2}}{4 α ( t - {t}^{′} )} ] )}{\sqrt{4 πα ( t - {t}^{′} )}} d {y}^{′}\end{matrix}$$

At block 60, the controller 30 is configured to select optimum weld parameters based on the optimised heat flux determined at box 58. The weld parameters may include the voltage of the weld torch, the velocity of the weld torch, and in the case of arc welding the speed of the filler wire. The controller may display the optimum weld parameters on the output device 38. Additionally, or alternatively the controller may send a signal to the welding apparatus 22 indicative of the optimum weld parameters that should be used.

At block 62, the components 12 are welded using the optimum weld parameters. In the example where the controller 30 outputs the optimum weld parameters to the output device 38, an operator may manually input the weld parameters to the weld apparatus via the welding apparatus input device 23. In the example where the controller 30 sends a signal to the welding apparatus 22, the signal may indicate the optimum welding parameters to be used. The actuator 25 of the welding apparatus 22 may then operate the welding torch, and if applicable the wire feed, using the optimum welding parameters to weld the two components together.

As indicated by the dotted line in FIG. 4, in examples where a sensor 52 is provided and where the processing capability is sufficient, the sensor may send information to the controller 30 relating to the temperature of the components. The controller may then validate the determined heat flux against the actual heat flux, and modify the optimised welding parameters accordingly.

The described method provides an improved determination of heat flux distribution, which means that the heat flux can be accurately optimised. Furthermore, the heat flux distribution can be solved more rapidly than methods of the prior art. In a test, one method of the prior art took 8 days to accurately determine the approximate heat flux distribution during welding of an assembly, whereas the present method achieved an accurate approximation of the heat flux distribution during welding for the same assembly in 1 day.

In further alternative embodiments, one of the welding parameters output from the apparatus 32 may be the optimum weld preparation geometry.

Due to the thickness of the components welded in the nuclear industry, the welds can take a long time to produce (e.g. several hours). An issue with the time taken to produce the welds is power outages. Currently if there is a power outage mid-weld the components need to be either scrapped or retreated for a long period of time (e.g. an 8 hour heat), because the exact retreatment time required is not known. A problem with this approach is that components may be scrapped when they do not need to be and/or components may be over heat treated.

Referring now to FIG. 5, a method of completing a partial weld and mitigating the aforementioned problems will be described.

Block 64 is similar to block 56 of FIG. 4, so will not be described in more detail here.

In block 66, the welding parameters (e.g. weld torch velocity and voltage) used to form the partial weld and the time the components 12 have been welded for are inputted to the controller 30. The welding parameters may be inputted manually by an operator using the input device and may be taken for example from the work instructions or the control settings of the welding apparatus 22. Alternatively or additionally, at least some of the weld parameters may be retrieved directly from the welding apparatus. In exemplary embodiments, the apparatus 32 may be used to form the partial weld (e.g. the method of FIG. 4 may be utilised). In embodiments, where temperature sensors are provided the temperature of the components during the welding process may also be input to the controller.

At block 67 the expected heat flux distribution during the formation of the weld is calculated. Similar to that previously described, the heat flux distribution is estimated to have a first section having a double conical distribution and a second section having a double ellipsoidal distribution. Once the heat flux distribution has been determined, the residual stresses in the components can be calculated, for example using finite element techniques. At block 68 the residual stresses in the components 12 are determined based on the expected heat flux distribution calculated at block 67.

At box 69, the residual stresses determined to be in the component 12 are compared to a threshold residual stress distribution. The controller 30 may perform this comparison, or the controller may output the calculated distribution to the output device 38 and an operator may perform the comparison.

If the residual stress distribution is equal to or below the threshold residual stress distribution then the components and the partial weld will be heat treated (as indicated at box 70). The type of heat treatment and the time required for the heat treatment will be selected based upon the residual stress distribution. It is known in the art how to relax stresses in a component using heat treatment, so this process will not be described in more detail here.

Once the components 12 have been heat treated, the components can be welded to complete the partial weld. At box 72, the welding parameters for the weld are selected by optimising the heat flux distribution. Box 72 is similar to boxes 58 and 60 of FIG. 4 so will not be described in more detail here.

At box 74 the weld between the components 12 is completed. The steps of box 74 are similar to those of box 62 of FIG. 4, so will not be described in more detail here.

If at box 69 the residual stresses are above a pre-determined level the components may be scrapped, as indicated by box 76.

As will be understood, using the method shown in FIG. 5 means that fewer components 12 may be scrapped unnecessarily, and the time taken to heat treat components with partial welds can be reduced. This is not possible with methods of the prior art because it takes too long to determine the heat flux distribution and therefore the residual stresses. However, due to the reduced time (from 8 days to 1 day) of accurate calculation of the heat flux distribution, it is possible to calculate the heat flux distribution and the residual stresses without delaying production for an extended period of time.

In the described examples, the welding parameters, e.g. the weld torch velocity and/or voltage, are optimised using iteration, but in alternative embodiments a neural network may be used to select the optimal welding parameters. Training the neural network may include calculating an expected heat flux distribution that will be generated in components during a welding process as a function of the geometrical dimensions of the components and the material properties of the components. The heat flux distribution may be constrained to be ellipsoidal in an initial weld region and conical in the remainder of the weld, similar to as described in the above examples. The inputs to input nodes of the neural network may include component geometry and/or material properties. Hidden nodes may be configured such that output nodes of the neural network output optimised welding parameters including for example weld torch velocity and/or voltage.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of completing a partial weld between two components, the method including:
determining geometrical dimensions of the components to be welded;
determining material properties of the components to be welded;
determining the velocity and the voltage of the weld torch used to form the partial weld and the time taken to form the partial weld; and
determining the expected residual stress due to the formation of the partial weld and predicting an expected heat flux distribution that has be generated in the components during formation of the partial weld as a function of geometrical dimensions of the components and material properties of the components,
wherein the heat flux distribution is constrained to be ellipsoidal in an initial weld region and conical in the remainder of the weld; and
comparing the expected residual stress to a threshold, and (i) under the condition that the residual stress is above a predetermined threshold scrapping said components, or (ii) under the condition that the residual stress is below a predetermined threshold heat treating the components.

2. The method according to claim 1, including determining the optimal voltage and velocity required to complete the weld by selecting an optimised weld torch velocity and voltage by selecting an iteration parameter of weld torch velocity and voltage,
calculating an expected heat flux distribution that will be generated in components during a welding process as a function of geometrical dimensions of the components and material properties of the components,
wherein the heat flux distribution is constrained to be ellipsoidal in an initial weld region and conical in the remainder of the weld, and
iterating using the iteration parameter until an optimised weld torch velocity and voltage is obtained

3. The method according to claim 1, including determining the optimal voltage and velocity required to complete the weld by using a trained neural network to select an optimised weld torch velocity and voltage;
wherein the neural network was trained by calculating an expected heat flux distribution that will be generated in components during a welding process as a function of the geometrical dimensions of the components and the material properties of the components, and
wherein the heat flux distribution was constrained to be ellipsoidal in an initial weld region and conical in the remainder of the weld.

4. The method according to claim 1, wherein the components are welded using arc welding.

5. The method according to claim 4, comprising providing a filler material in the form of a wire, and determining the wire feed speed used in the welding process as a function of the expected heat flux distribution.

6. The method according to claim 1, wherein the components are welded using electron beam welding or laser welding.

7. The method according to claim 1, comprising using temperature sensors to measure the temperature of the components during the welding process, and modifying said heat flux distribution as a function of the measured temperature.

8. The method according to claim 1, comprising analytically computing a transient thermal field as a function of the heat flux distribution, wherein the transient thermal field (T) is proportional to the integral:
$${\int }_{0}^{t} \{ \begin{matrix}( {Q}_{{0}_{c r}} {B}_{T} {D}_{{T}_{c}} {L}_{{T}_{r}} ) + ( {Q}_{{0}_{c f}} {B}_{T} {D}_{T c} {L}_{{T}_{f}} ) + \\ ( {Q}_{{0}_{D r}} {B}_{T} {D}_{T e} {L}_{{T}_{r}} ) + ( {Q}_{{0}_{D f}} {B}_{T} {D}_{T e} {L}_{{T}_{f}} )\end{matrix} \} d {t}^{′}$$
wherein Q_{0cr}, Q_{0cf}, Q_{0Dr}, Q_{0df} is the maximum heat flux in a respective quadrant of the distribution; B_{T} is a heat kurnel in the x-coordinate; D_{Tc}, D_{Te} is a is a heat kurnel in the y-coordinate; and L_{Tr}, L_{Tf} is a is a heat kurnel in the z-coordinate.

9. A method comprising:
selecting an optimised weld torch velocity and voltage by selecting an iteration parameter of weld torch velocity and voltage,
calculating an expected heat flux distribution that will be generated in components during a welding process as a function of geometrical dimensions of the components and material properties of the components,
wherein the heat flux distribution is constrained to be ellipsoidal in an initial weld region and conical in the remainder of the weld, and
iterating using the iteration parameter until an optimised weld torch velocity and voltage is obtained.

10. The method according to claim 9, wherein the heat flux generated during the welding process is estimated to have a double ellipsoidal distribution in the initial region of the weld, and a double conical distribution in the remainder of the weld.

11. A method of welding two adjacent components together, the method comprising:
determining geometrical dimensions of the components to be welded;
determining material properties of the components to be welded;
performing the method of claim 9; and
setting the welding torch to weld the components at said determined optimum velocity and voltage.

12. An apparatus comprising:
at least one processor,
at least one memory comprising computer readable instructions;
the at least one processor being configured to read the computer readable instructions and cause performance of the method of claim 9.

13. The apparatus according to claim 12, comprising a welding apparatus having a weld torch and an actuator, the welding apparatus being configured to receive a signal indicative of the optimum voltage and velocity of the weld torch from the controller, and the actuator being configured to operate the weld torch at said optimum voltage and velocity.

14. The apparatus according to claim 13, wherein the apparatus comprises one or more sensors for measuring the temperature of a component during a welding process, the sensors being arranged to send a signal to the controller indicative of the measured temperature.
